(19) United States
(12) Patent Application Publication
(10) Pub. No.: US 2025/0244278 A1
(43) Pub. Date: Jul. 31, 2025

(54) STRUCTURAL HEALTH MONITORING SYSTEM, MONITORING CIRCUIT, AND STRUCTURAL HEALTH MONITORING METHOD

(71) Applicants: MITSUBISHI HEAVY INDUSTRIES, LTD., Tokyo (JP); JAPAN AEROSPACE EXPLORATION AGENCY, Tokyo (JP)

(72) Inventors: Yosuke SAKAI, Tokyo (JP); Shuhei MUTO, Tokyo (JP); Toshiya SAITO, Tokyo (JP); Kosuke KAWAKAMI, Tokyo (JP)

(21) Appl. No.: 19/014,223

(22) Filed: Jan. 9, 2025

(30) Foreign Application Priority Data
Jan. 29, 2024 (JP) 2024-010649

(51) Int. Cl. G01N 27/24; G01N 27/22

(52) U.S. Cl. CPC G01N 27/24; G01N 27/221

(57) ABSTRACT

There is provided a structural health monitoring system that has a simpler configuration and enables reduction of a burden of an installation work. The structural health monitoring system includes a monitoring circuit configured to be fixed to a surface of a monitoring object, and a determiner configured to determine health of the monitoring object based on a physical quantity detected in the monitoring circuit. The monitoring object includes a base material having conductivity, and an insulating layer fixed to a surface of the base material. The monitoring circuit includes a detector configured to detect an electrostatic capacitance as the physical quantity, and a conductive path connected in series to the detector. At least the conductive path is fixed to a surface of the insulating layer.

### BACKGROUND OF THE INVENTION

### Field of the Invention

The present disclosure relates to a system that monitors health of a structure.

### Description of the Related Art

Structural health monitoring (SHM) means that a sensor is attached to a structure to detect a physical quantity, and a damaged/deteriorated portion of the structure is diagnosed and predicted based on the detected physical quantity. JP H6-298192 A discloses a structural-material damage detection device suitably used for, for example, an aircraft.

The structural-material damage detection device disclosed in JP H6-298192 A includes a capacitor that is formed by sandwiching a sheet-like insulating dielectric between sheet-like conductors and is fixed along a surface of a structural material, and a capacitor electrostatic capacitance measurement circuit detecting an electrostatic capacitance of the capacitor. The capacitor is formed by sandwiching the sheet-like insulating dielectric such as oil-impregnated paper, a polyester film, and barium titanate, between the sheet-like conductors such as copper foils and aluminum foils. In JP H6-298192 A, when an inspection object is damaged, the capacitor is also damaged in proportion to the damage of the inspection object, and the electrostatic capacitance of the capacitor is changed. In JP H6-298192 A, detecting the change of the electrostatic capacitance makes it possible to immediately detect a damaged portion even during flight.

The structural-material damage detection device disclosed in JP H6-298192 A can immediately detect the damaged portion even during flight by a simple configuration including the existing capacitor and the capacitor electrostatic capacitance measurement circuit detecting the capacitance of the capacitor. However, in a case where the device is provided at each of a number of positions of the inspection object, the number of capacitors to be prepared is increased, and a burden of a work for installing the capacitors is large. In addition, there is an issue for practical use that, to manufacture the capacitors matched to a shape of the inspection object, a large cost and labor are necessary.

Thus, the present disclosure aims to provide a structural health monitoring system that has a simpler configuration and enables reduction of a burden of an installation work.

### SUMMARY OF THE INVENTION

A structural health monitoring system according to the present disclosure includes a monitoring circuit configured to be fixed to a surface of a monitoring object, and a determiner configured to determine health of the monitoring object based on a physical quantity detected in the monitoring circuit.

The monitoring object includes a base material having conductivity, and an insulating layer fixed to a surface of the base material.

The monitoring circuit includes a detector configured to detect an electrostatic capacitance as the physical quantity, and a conductive path connected in series to the detector, and at least the conductive path is fixed to a surface of the insulating layer.

A monitoring circuit according to the present disclosure is fixed to a surface of a monitoring object.

The monitoring object includes a base material having conductivity, and an insulating layer fixed to a surface of the base material.

The monitoring circuit includes a detector configured to detect an electrostatic capacitance, and a conductive path connected in series to the detector, and at least the conductive path is fixed to a surface of the insulating layer.

A structural health monitoring method according to the present disclosure determines health of a monitoring object based on an electrostatic capacitance detected in a monitoring circuit fixed to the monitoring object.

The monitoring object includes a base material having conductivity, and an insulating layer fixed to a surface of the base material.

The monitoring circuit includes a detector configured to detect an electrostatic capacitance as a physical quantity, and a conductive path connected in series to the detector, and at least the conductive path is fixed to a surface of the insulating layer.

In a damaged state where the base material is damaged, electrostatic capacitances of parasitic capacitors generated by the base material, the insulating layer, and the conductive path stacked in order are detected.

In the present disclosure, when the conductive path is broken at any portion with damage of the base material, the parasitic capacitors are generated by the base material, the insulating layer, and the conductive path. Detecting the electrostatic capacitances of the parasitic capacitors makes it possible to determine damage of the base material. In the present disclosure, the base material and the insulating layer of the monitoring object are used as components of the parasitic capacitors. Therefore, the conductive path and the detector are added to existing components of an aircraft. Thus, a simpler configuration is achievable, and a burden of the installation work can be reduced.

### BRIEF DESCRIPTION OF THE DRAWINGS

FIG. 1 is a diagram illustrating a configuration of a structural health monitoring system according to an embodiment;

FIG. 2 is a diagram to explain a monitoring state in the structural health monitoring system;

FIG. 3 is a diagram to explain a potential difference, electrostatic induction, and a capacitive coupling state occurring in a detection circuit after damage in the structural health monitoring system;

FIG. 4 is a diagram to explain a method of detecting a damaged position in the structural health monitoring system;

FIG. 5 is a diagram illustrating a structural health monitoring system according to a first modification;

FIG. 6 is a diagram illustrating a structural health monitoring system according to a second modification;

FIG. 7 is a diagram to explain an object to which the structural health monitoring system is applied; and

FIG. 8 is a diagram to explain a method of determining presence/absence of damage of a base material based on electric resistance.

### DETAILED DESCRIPTION OF THE PREFERRED EMBODIMENT

A preferred embodiment of a structural health monitoring system 1 according to the present disclosure is described.

The structural health monitoring system 1 detects an electrostatic capacitance, and determines health of a structure by determining change of the electrostatic capacitance. The change is determined by comparing the electrostatic capacitance in a state where a monitoring circuit 10 is in a healthy state and electrostatic capacitances of parasitic capacitors generated when the monitoring circuit 10 is broken.

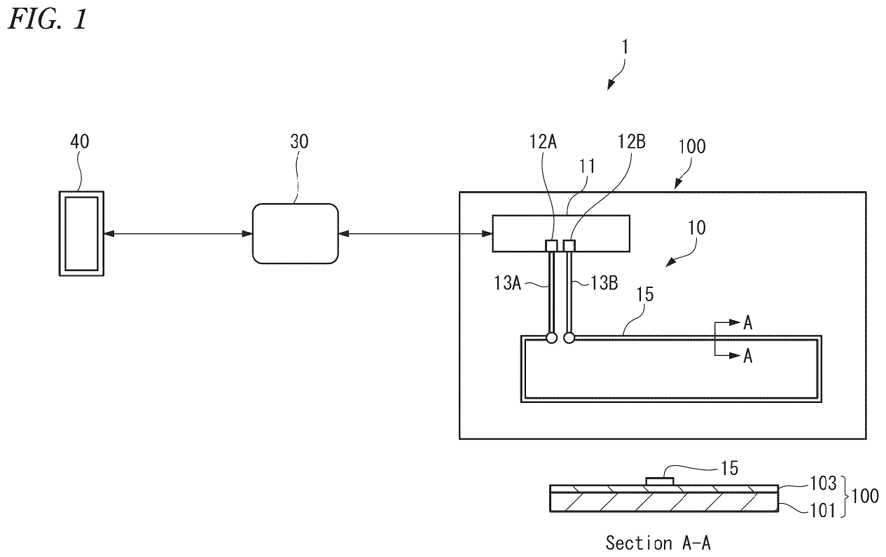

### [Configuration of Structural Health Monitoring System 1: See FIG. 1]

The structural health monitoring system 1 includes the monitoring circuit 10 fixed to a surface of a monitoring object 100, an RFID reader 30 reading an electrostatic capacitance detected in the monitoring circuit 10 by wireless communication, and a mobile device 40 obtaining information on the electrostatic capacitance from the RFID reader 30 and processing the information.

### [Monitoring Object 100: See FIG. 1]

The monitoring object 100 includes a base material 101 having conductivity, and an insulating layer 103 made of an electric insulating material and covering a surface of the base material 101. Although an object directly subjected to health determination by the structural health monitoring system 1 is the base material 101, when damage, for example, a crack occurs on the surface of the base material 101, a crack may also occur on the insulating layer 103 covering the surface of the base material 101 with the crack of the base material 101. The structural health monitoring system 1 generates parasitic capacitors between the monitoring circuit 10 and the monitoring object 100 by using the fact that the base material 101 having conductivity and the insulating layer 103 are stacked. Details of the parasitic capacitors are described in description of the monitoring circuit 10.

In this example, the monitoring object 100 having a rectangular shape in a planar view is illustrated; however, this merely illustrates a part of a structure to be monitored.

The base material 101 is made of a metal material such as iron, an iron alloy, aluminum, and an aluminum alloy, and has conductivity. The insulating layer 103 includes a form not derived from the base material 101 and a form derived from the base material 101. The form not derived from the base material 101 includes a coating that is typically formed by application of coating materials made of a resin material. The form derived from the base material 101 includes alumite when the base material 101 is made of aluminum. The alumite is a coating film made of an oxide of aluminum artificially generated on a surface of aluminum by performing electrolytic treatment on aluminum with an anode. The insulating layer 103 tightly adheres to the surface of the base material 101 and does not easily peel from the base material 101. Thicknesses of the base material 101 and the insulating layer 103 are optional, and the insulating layer 103 is normally thinner than the base material 101.

### [Monitoring Circuit 10: See FIG. 1]

The monitoring circuit 10 includes a detector 11 that can detect the electrostatic capacitance, and a conductive path 15 connected to the detector 11. The detector 11 and the conductive path 15 are fixed, by bonding or the like, to the surface of the insulating layer 103 at predetermined positions of the monitoring object 100.

### <Detector 11>

As the detector 11, an LCR meter is adopted as an example. The LCR meter is a meter that applies an alternating-current voltage of a constant frequency to a measurement object to measure a phase difference with an alternating current, and determines an electrostatic capacitance from the phase difference and impedance. The LCR meter can determine, in addition to the electrostatic capacitance (C), inductance (L) and resistance (R), but the electrostatic capacitance is determined in the structural health monitoring system 1.

In the detector 11, paired lead wires 13A and 13B are respectively connected to terminals 12A and 12B. Both ends of the conductive path 15 are connected between the lead wires 13A and 13B, and the detector 11 and the conductive path 15 form a series circuit. The detector 11 as the LCR meter can determine the electrostatic capacitance between the conductive path 15 and the monitoring object 100 by applying the alternating-current voltage of the constant frequency to the conductive path 15.

As a preferred form, the detector 11 includes a wireless function. More specifically, the detector 11 is included in a radio frequency identification (RFID) system, namely, in a system that exchanges data on a tag in a noncontact manner by using radio waves. The electrostatic capacitance determined by the detector 11 is read by the RFID reader 30 through wireless communication. The detector 11 is provided as an RFID tag. The RFID tag preferably operates by, for example, wireless power from the RFID reader 30. This makes it possible to eliminate labor for providing a power supply operating the detector 11 on the monitoring object 100 side.

### <Conductive Path 15>

The conductive path 15 is formed of a linear film or a wire material made of a conductive material. The conductive path 15 is fixed to the insulating layer 103 by optional means, which may include a metal tape that is adhered to a predetermined position of the insulating layer 103, and conductive paint containing conductive fillers such as metal powder that is applied to a predetermined position of the insulating layer 103 and hardened.

In the structural health monitoring system 1, it is anticipated that, when the monitoring object 100 is damaged, an electric path of the conductive path 15 is disconnected and broken. When the conductive path 15 is broken, parasitic capacitors are generated because the insulating layer 103 is present between the conductive path 15 and the base material 101 both having conductivity. As described above, in the present embodiment, one conductive body and the dielectric for generating the parasitic capacitors are configured by the base material 101 and the insulating layer 103 of the monitoring object 100.

### [RFID Reader 30: See FIG. 1]

The RFID reader 30 obtains information on the electrostatic capacitance detected by the detector 11 of the monitoring circuit 10, from the detector 11. The RFID reader 30 transfers the obtained electrostatic capacitance to the mobile device 40. As the RFID reader 30, a portable RFID reader of a so-called handy type is adopted. An operator performing the structural health monitoring of the monitoring object 100 carries the mobile device 40 and the RFID reader 30 to perform the structural health monitoring of the monitoring object 100.

The RFID reader 30 can include another function, for example, a function of an RFID writer. In this case, the RFID reader 30 can energize the detector 11 by radio waves of transmission radio waves to detect the electrostatic capacitance.

Note that means wirelessly communicating with the detector 11 is not limited to the RFID tag. Examples of the means include a wireless LAN, Wi-Fi (Registered Mark), and Bluetooth (Registered Mark). Further, communication means with the detector 11 is not limited to wireless communication, and may be wired communication means such as an electric wire and an optical fiber.

### [Mobile Device 40: See FIG. 1]

The mobile device 40 processes the information on the electrostatic capacitance obtained from the RFID reader 30. The mobile device 40 is an information device that has a small size and a light weight and is easily carried, and corresponds to a laptop computer, a smartphone, a tablet device, and the like.

The processing of the information on the electrostatic capacitance performed by the mobile device 40 includes evaluation of the information. For example, an actual measured value of the electrostatic capacitance and a reference value of the electrostatic capacitance provided as numerical values are compared. In a case where the actual measured value exceeds the reference value, it can be determined that the conductive path 15 is broken and the monitoring object 100 is damaged. The processing of the information performed by the mobile device 40 includes display of a result of the determination on a display. Further, the processing of the information performed by the mobile device 40 may include storage of the actual measured value of the electrostatic capacitance and the determination result that have been obtained.

Note that although the example in which the RFID reader 30 and the mobile device 40 are independently present has been described herein, an apparatus including functions of both of the RFID reader 30 and the mobile device 40 can be used in the present disclosure.

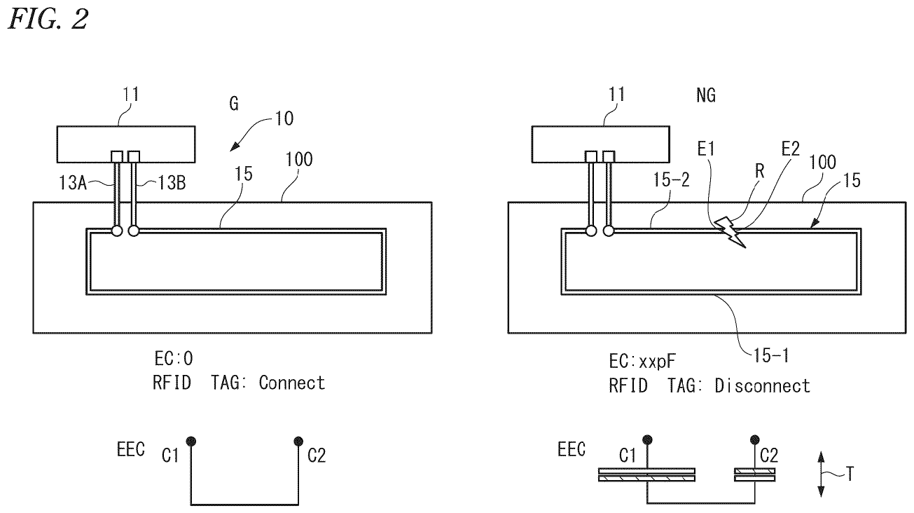

### [Difference of Circuit Between Healthy State and Damaged State: See FIG. 2]

Difference of the electrostatic capacitance between a healthy state and a damaged state of the monitoring object 100 is described with reference to FIG. 2. When the monitoring object 100 is in the healthy state, the conductive path 15 is not broken and is also in the healthy state. In contrast, when the monitoring object 100 is damaged, a portion of the conductive path 15 corresponding to the damage is broken. In other words, the healthy state of the monitoring object 100 means that the conductive path 15 is also healthy, and the damaged state of the monitoring object 100 means that the conductive path 15 is also damaged. An alternating-current voltage of a constant frequency is applied to the conductive path 15 from the detector 11.

### <Healthy State: See G in FIG. 2>

When the conductive path 15 is healthy, and the lead wire 13A, the conductive path 15, and the lead wire 13B are conductive, a potential difference does not occur on the conductive path 15 and its surroundings, or the potential difference is small if any. Therefore, electrostatic induction does not occur on the base material 101. Thus, the electrostatic capacitance does not occur among the conductive path 15, the insulating layer 103, and the base material 101, or the electrostatic capacitance is small if any. The electrostatic capacitance detected by the detector 11 at this time is EC=0 or EC≈0, and the mobile device 40 that obtains the measurement result of the electrostatic capacitance through the RFID reader 30 can display a message “monitoring object 100 is healthy” or the like on a display 41. Note that an equivalent electric circuit EEC is illustrated in FIG. 2.

### <Damaged State: See NG in FIG. 2>

It is assumed that any portion of the conductive path 15 is broken. The breakage is denoted by a reference symbol R. The electric circuit is divided into two paths electrically independent of each other at the breakage R as a boundary. One of the paths is a first path 15-1, and the other path is a second path 15-2. The first path 15-1 is longer than the second path 15-2 due to the position of the breakage R shown in the example in FIG. 2. The lengths of the first path 15-1 and the second path 15-2 in a case where the conductive path is divided into two paths are determined by the position of the breakage R.

Voltages are applied to both ends E1 and E2 of the broken conductive path 15. As a result, a potential difference occurs between the end E1 and the end E2. By the potential difference, electrostatic induction is caused on a surface layer of the base material 101 through the insulating layer 103, and capacitive coupling occurs. Accordingly, the insulating layer 103 is present between the first path 15-1 and the base material 101 in a thickness direction T of a region of the first path 15-1, which generates a parasitic capacitor C1. Further, the insulating layer 103 is present between the second path 15-2 and the base material 101 in the thickness direction T of a region of the second path 15-2, which generates a parasitic capacitor C2. An electrostatic capacitance EC1 and an electrostatic capacitance EC2 are respectively generated in the parasitic capacitor C1 and the parasitic capacitor C2.

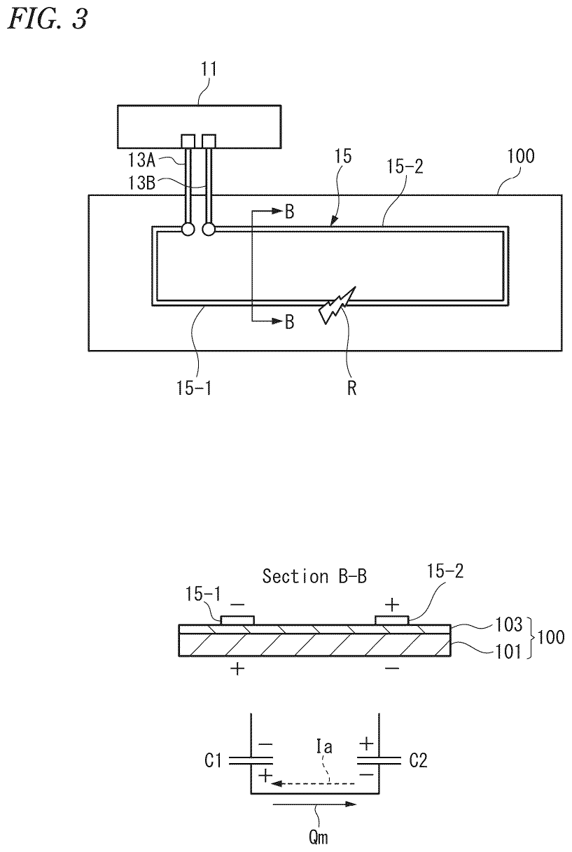

### [Potential Difference, Electrostatic Induction, and Capacitive Coupling State in Damaged State: See FIG. 3]

A potential difference, electrostatic induction, and a capacitive coupling state in the damaged state are described.

In the following description, it is assumed that the breakage R occurs at a position illustrated in the plan view of FIG. 3 in the conductive path 15, and the conductive path 15 is divided into two paths of the first path 15-1 and the second path 15-2. In this example, the length of the first path 15-1 and the length of the second path 15-2 are substantially equal to each other.

As illustrated in the plan view of FIG. 3 and a B-B cross-sectional view (Section B-B) of FIG. 3, it is assumed that a portion of the first path 15-1 is charged to negative (−) and a portion of the second path 15-2 is charged to positive (+). As a result, a portion of the base material 101 facing the first path 15-1 through the insulating layer 103 is charged to positive (+) by electrostatic induction, and the parasitic capacitor C1 is generated by the first path 15-1, the insulating layer 103, and the base material 101. Further, a portion of the base material 101 facing the second path 15-2 through the insulating layer 103 is charged to negative (−) by electrostatic induction, and the parasitic capacitor C2 is generated by the second path 15-2, the insulating layer 103, and the base material 101. A circuit diagram below Section B-B in FIG. 3 illustrates the configuration as an equivalent electric circuit. As illustrated in the circuit diagram, the parasitic capacitor C1 and the parasitic capacitor C2 are capacitively coupled, charge movement Qm by polarization occurs from the parasitic capacitor C1 side to the parasitic capacitor C2 side, and an apparent current Ia flows in a direction opposite thereto.

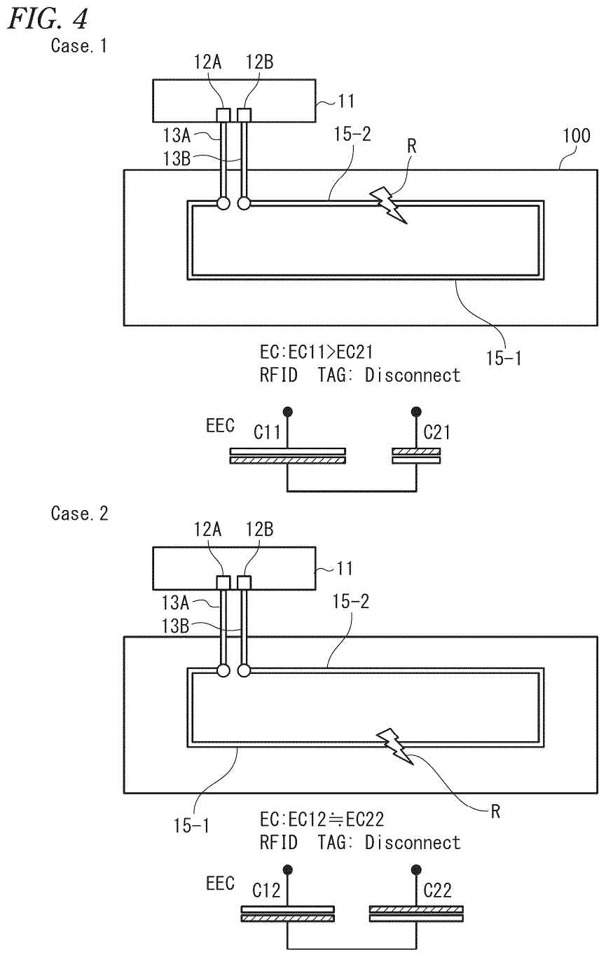

### [Estimation of Breakage Position: See FIG. 4]

According to the structural health monitoring system 1, it is possible to estimate the position of the breakage R occurring in the conductive path 15. Description is given with reference to FIG. 4. The above-described mobile device 40 can estimate the position.

The conductive paths 15 different in position of the breakage R are assumed. Note that Case. 1 in FIG. 4 illustrates an example in which the first path 15-1 is longer than the second path 15-2, and Case. 2 in FIG. 4 illustrates an example in which the first path 15-1 and the second path 15-2 are substantially equal in length to each other.

In Case. 1, an electrostatic capacitance of a parasitic capacitor C11 is denoted by EC11, and an electrostatic capacitance of a parasitic capacitor C21 is denoted by EC21. The electrostatic capacitance EC11 and the electrostatic capacitance EC21 are respectively specified based on the lengths of the conductive paths of the first path 15-1 and the second path 15-2. Therefore, the electrostatic capacitance EC11 and the electrostatic capacitance EC21 have the following relationship.

Case. 1 (unit: pF): Electrostatic capacitance EC11>Electrostatic capacitance EC21

$$Combined electrostatic capacitance 1 = ( EC 11 * EC 21 ) / ( EC 11 + EC 21 )$$

In Case. 2, an electrostatic capacitance of a parasitic capacitor C12 is denoted by EC12, and an electrostatic capacitance of a parasitic capacitor C22 is denoted by EC22. The electrostatic capacitance EC12 and the electrostatic capacitance EC22 are also respectively specified based on the lengths of the conductive paths of the first path 15-1 and the second path 15-2. Therefore, the electrostatic capacitance EC12 and the electrostatic capacitance EC22 have the following relationship.

Case. 2 (unit: pF): Electrostatic capacitance EC12≈Electrostatic capacitance EC22

$$Combined elecreostatic capacitance 2 = ( EC 12 * EC 22 ) / ( EC 12 + EC 22 )$$

The two electrostatic capacitances have relationship of combined electrostatic capacitance 1<combined electrostatic capacitance 2. This indicates that the breakage position is a position corresponding to the combined electrostatic capacitance. Therefore, the combined electrostatic capacitance can be used for estimation of the breakage position. Although the above-described example is based on the premise that a length of a detection circuit, a dielectric constant of the insulating layer, and the like are previously obtained in laying, the position of the breakage R can be roughly estimated from the detected electrostatic capacitance.

### [Effects Achieved by Monitoring Circuit 10]

Effects achieved by the above-described monitoring circuit 10 are described.

Presence/absence of breakage of the conductive path 15 is determined based on the detected electrostatic capacitance. In other words, it is possible to determine that damage such as a crack does not occur on the monitoring object 100 provided with the conductive path 15, based on the fact that, in the healthy state where the conductive path 15 is not broken, no electrostatic capacitance occurs around the conductive path 15, or the electrostatic capacitance is small if any. In addition, for example, the combined electrostatic capacitance by serial direction of an electrostatic capacitance EC1n corresponding to the first path 15-1 and an electrostatic capacitance EC2n corresponding to the second path 15-2 after breakage is detected, and is compared with the electrostatic capacitance in the healthy state that is substantially zero (0). This makes it possible to determine that the monitoring object 100 is damaged with high accuracy.

In particular, the monitoring circuit 10 can detect the electrostatic capacitances of the parasitic capacitors generated when the conductive path 15 is broken, and determine that the monitoring object 100 is broken, unlike a case where a capacitor (existing capacitor) previously fabricated is prepared on the conductive path 15. Therefore, the monitoring circuit 10 uses the base material 101 and the insulating layer 103 configuring the monitoring object 100 for elements of the parasitic capacitors. Thus, it is possible to generate the parasitic capacitors for detecting the electrostatic capacitances only by adding the conductive path 15. As a result, the monitoring circuit 10 enables to minimize the elements to be added for generating the parasitic capacitors.

Further, according to the monitoring circuit 10, while the electrostatic capacitance in the healthy state is substantially zero (0), the electrostatic capacitance remarkably higher than zero can be detected irrespective of the breakage position of the conductive path 15. This makes it possible to determine the breakage with high accuracy. In contrast, in the case where the capacitor (existing capacitor) previously fabricated is prepared, a change amount of the electrostatic capacitance caused by damage may be small, and the damage may not be recognized.

In addition, the position of the breakage R in the conductive path 15, namely, the position of the breakage R in the monitoring object 100 can be estimated from the number of electrostatic capacitances ECn1, ECn2, . . . held by a plurality of conductive paths after breakage. For example, presence/absence of breakage in the conductive path can be determined by detecting electric resistance values in the conductive path, but it is difficult to estimate the position of the breakage. This is because the method of detecting the electric resistance value determines only presence/absence of conductivity of the conductive path.

Although the preferred embodiment of the present disclosure is described above, the configurations described in the embodiment can be selected or appropriately changed to other configurations.

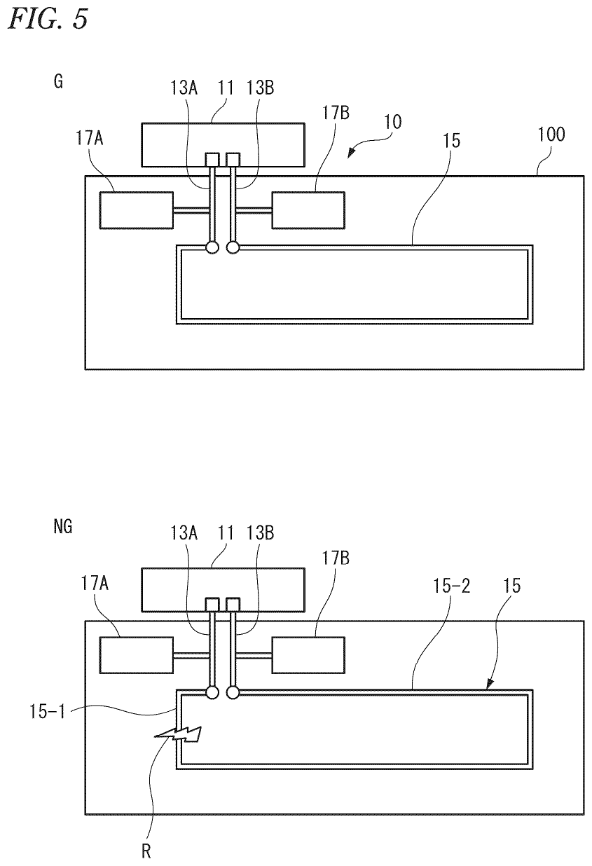

### [Provision of Buffer Film: See FIG. 5]

For example, as illustrated in FIG. 5, buffer films 17A and 17B having conductivity can be connected to the basic monitoring circuit 10. Areas of the buffer films 17A and 17B are set to be greater than an area of the conductive path 15 based on an electrostatic capacitance measurement range and a resolution of the detector 11. As compared with the case of only the conductive path 15, providing the buffer films 17A and 17B makes it possible to control the electrostatic capacitances generated in the circuit when damage occurs, to a desired range.

It is assumed that the breakage R illustrated in FIG. 5 occurs in the conductive path 15. As a result, in addition to the portion corresponding to the first path 15-1, an electrostatic capacitance for the buffer film 17A is also generated. Therefore, the electrostatic capacitance is increased as compared with the case of only the first path 15-1. When the electrostatic capacitance of the portion corresponding to the first path 15-1 is denoted by EC11 and the electrostatic capacitance corresponding to the buffer film 17A is denoted by EC17A, the electrostatic capacitance of EC11+EC17A=C1s can be detected in total. In this case, since relationship of EC11<<EC17A is established, EC11<<C1s holds. This is true of the second path 15-2.

As described above, connecting the buffer films 17A and 17B makes it possible to detect the large electrostatic capacitance in the monitoring circuit 10. Therefore, for example, even in a case of using the detector 11 that has rough detection limit resolution of the electrostatic capacitance, providing the buffer films 17A and 17B makes it possible to surely detect damage of the monitoring object 100. In other words, providing the buffer films 17A and 17B makes it possible to adjust the range of the electrostatic capacitance detected when damage occurs.

The buffer films 17A and 17B can be made of a material same as or different from the conductive material of the conductive path 15. The connection positions of the buffer films 17A and 17B are not limited to the illustrated lead wires 13A and 13B, and the buffer films 17A and 17B may be connected to any positions of the conductive path 15. Further, areas of the buffer film 17A and the buffer film 17B may be equal to or different from each other. The number of buffer films to be provided is not limited to two, and one or three or more buffer films may be provided. The buffer films 17A and 17B can be provided when the monitoring circuit 10 including the conductive path 15 is installed on the monitoring object 100. This makes it possible to minimize an additional cost.

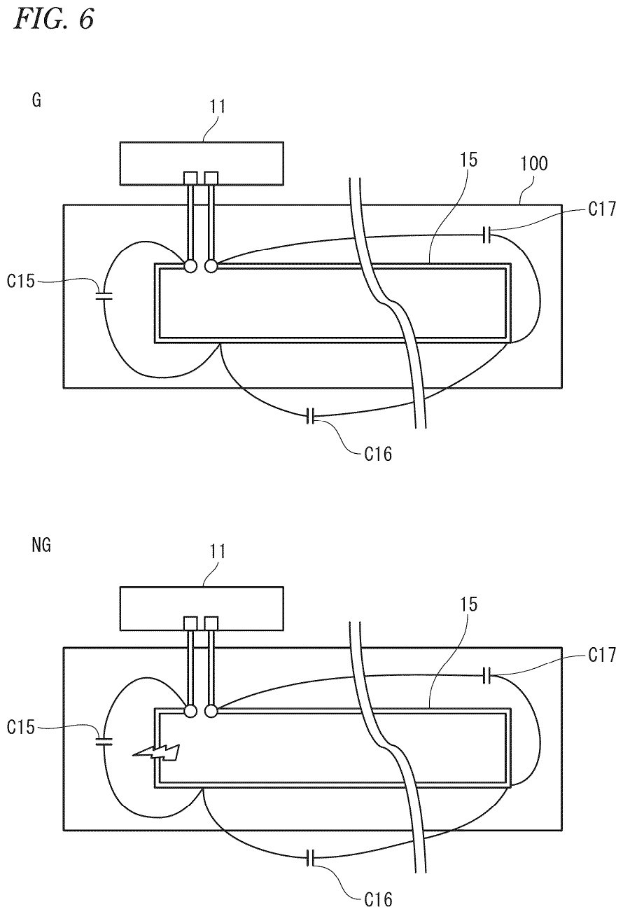

### [Addition of Capacitor (Existing Capacitor): See FIG. 6]

In place of the buffer films 17A and 17B, capacitors C15, C16, C17, . . . can be intentionally connected to the basic monitoring circuit 10 as illustrated in FIG. 6. The capacitors C15, C16, C17, are referred to as existing capacitors in the present disclosure because the capacitors C15, C16, C17, . . . each have a configuration as a capacitor from the beginning. When the existing capacitors C15, C16, C17, . . . are connected to the monitoring circuit 10, effects similar to the effects achieved by connection of the buffer films 17A and 17B can be achieved. In addition, the electrostatic capacitances of the existing capacitors C15, C16, C17, . . . are known. Therefore, damage of the monitoring object 100 can be determined with higher accuracy as compared with the case where the buffer films 17A and 17B are connected. Note that, in addition to the buffer films 17A and 17B, the existing capacitors C15, C16, C17, . . . may be provided.

The number of existing capacitors C15, C16, C17, . . . connected to the monitoring circuit 10 is optional, and one or more existing capacitors can be connected to the monitoring circuit 10. In a case where the plurality of existing capacitors C15, C16, C17, . . . are connected, the electrostatic capacitances of the existing capacitors may be equal to or different from one another.

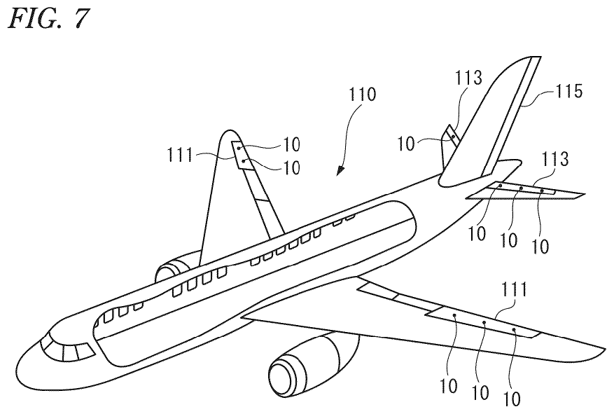

### [Application Object of Structural Health Monitoring System 1: See FIG. 7]

Although an application object of the structural health monitoring system 1 is optional, an aircraft 110 is described as an example. The structural health monitoring system 1 can be applied to a mobile body such as a flying object and a rocket other than the aircraft 110, and can be applied to a fixed object such as a bridge.

As an example, the monitoring circuit 10 is provided on each of a plurality of components of an airframe of the aircraft 110, such as an aileron 111, an elevator 113, and a rudder 115. In addition, a plurality of monitoring circuit 10 are provided on each of the components in some cases. Each of the components of the aircraft 110 is the monitoring object 100, and includes the base material 101 and the insulating layer 103. The monitoring circuit 10 is fixed to the insulating layer 103. An identification symbol (ID) is assigned in particular to each of the detectors 11 of the plurality of monitoring circuits 10, and the detected electrostatic capacitance is read by the RFID reader 30 in association with the ID.

Presence/absence of damage of the aircraft 110 is determined using the structural health monitoring system 1 every time the aircraft 110 is parked for inspection. An inspector carries at least the RFID reader 30 out of the RFID reader 30 and the mobile device 40, and sequentially goes around inspection objects such as the aileron 111. The mobile device 40 can be held by an inspector different from the inspector who carries the RFID reader 30 and performs inspection, and a determination result can be recognized.

For example, it is assumed that n monitoring circuits 10 are provided with predetermined intervals on the aileron 111. For example, IDs 10-1, 10-2, 10-n are previously assigned to the respective monitoring circuits 10. A predetermined communication range with the RFID reader 30 is set to each of the monitoring circuits 10. When the RFID reader 30 reaches the communication range of the monitoring circuit 10 having the ID=10-1, the RFID reader 30 reads an actual measured value of the electrostatic capacitance detected by the detector 11 of the circuit 10-1. Thereafter, when the RFID reader 30 reaches the communication range of the monitoring circuit 10 having the ID=10-2, a communication partner is switched from the circuit 10-1 to the circuit 10-2, and the RFID reader 30 reads the actual measured value of the electrostatic capacitance detected by the detector 11 of the circuit 10-2. When the inspector finishes detection, by the RFID reader 30, of the electrostatic capacitances of up to the circuit 10-n of the aileron 111, the inspector thereafter sequentially inspects, for example, the plurality of monitoring circuits 10 belonging to the elevator 113.

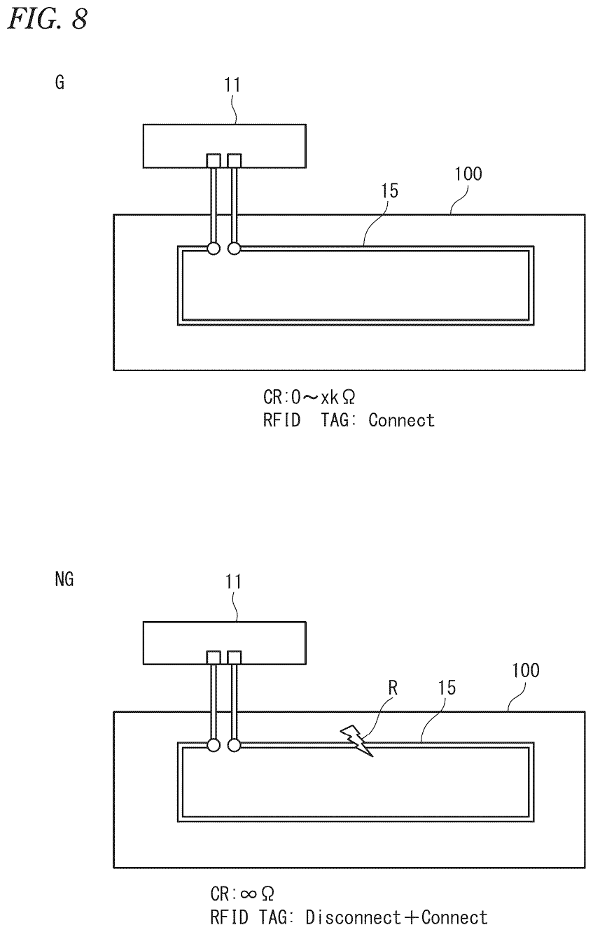

### [Determination of Damage by Detection of Another Physical Quantity: See FIG. 8]

In the present embodiment, the electrostatic capacitance is adopted as the physical quantity to be detected; however, to determine damage of the base material 101 based on breakage of the conductive path 15, other electric characteristics, for example, electric resistance can be adopted as the physical quantity to be detected. More specifically, when the conductive path 15 is connected (Connect) as illustrated in the healthy state in FIG. 8, the detector 11 measures a circuit resistance CR in a predetermined range (CR: 0 to *kΩ). Thus, it is possible to determine that the conductive path 15 is healthy. In contrast, when the conductive path 15 is broken (Disconnect) as illustrated in the damaged state in FIG. 8, the circuit resistance CR shows infinity (CR: ∞Ω). Thus, it is possible to determine that the conductive path 15 is in the broken state. However, according to the study by the present disclosers, it is found that the predetermined circuit resistance CR is measured (Connect) even though the conductive path 15 is broken, and damage of the base material 101 cannot be determined with high accuracy by the method of detecting the circuit resistance CR. In contrast, according to the present disclosure in which the electrostatic capacitance is detected, when the conductive path 15 is broken, it is possible to determine damage of the base material 101 with high accuracy by detecting the electrostatic capacitance.

### [Supplements]

[1] A structural health monitoring system (1), including:
   a monitoring circuit (10) configured to be fixed to a surface of a monitoring object (100); and
   a determiner (30 and 40) configured to determine health of the monitoring object (100) based on a physical quantity detected in the monitoring circuit, in which
   the monitoring object (100) includes a base material (101) having conductivity, and an insulating layer (103) fixed to a surface of the base material (101),
   the monitoring circuit (10) includes a detector (11) configured to detect an electrostatic capacitance as the physical quantity, and a conductive path (15) connected in series to the detector (11), and
   at least the conductive path (15) is fixed to a surface of the insulating layer (103).
[2] The structural health monitoring system (1) according to [1], in which the determiner (30 and 40) determines a healthy state where the base material (101) is not damaged or a damaged state where the base material (101) is damaged, based on the electrostatic capacitance obtained from the detector (11).
[3] The structural health monitoring system (1) according to [1] or [2], in which
   in the damaged state, parasitic capacitors are generated by the base material (101), the insulating layer (103), and the conductive path (15) stacked in order, and
   the detector (11) detects electrostatic capacitances of the parasitic capacitors.
[4] The structural health monitoring system (1) according to any one of [1] to [3], in which
   when the conductive path (15) is broken with damage of the base material (101), and is divided into at least two paths of a first path (15-1) and a second path (15-2) electrically independent of each other,
   the detector (11) detects one or both of a first electrostatic capacitance (EC1) of a parasitic capacitor (C1) generated in the first path (15-1) and a second electrostatic capacitance (EC2) of a parasitic capacitor (C2) generated in the second path (15-2), and
   the determiner (30 and 40) estimates a position of the breakage in the conductive path based on one or both of the first electrostatic capacitance (EC1) and the second electrostatic capacitance (EC2).
[5] The structural health monitoring system (1) according to any one of [1] to [4], in which
   the monitoring circuit (10) includes one or more buffer films (17A and 17B) each made of a conductive material and electrically connected to the conductive path (15), and
   the buffer films (17A and 17B) are fixed to the surface of the insulating layer (103) of the monitoring object (100).
[6] The structural health monitoring system (1) according to any one of [1] to [5], in which
   the monitoring circuit (10) includes one or more existing capacitors (C15, C16, C17, . . . ) electrically connected to the conductive path (15), and
   the existing capacitors (C15, C16, C17, . . . ) are fixed to the surface of the insulating layer (103) of the monitoring object (100).
[7] The structural health monitoring system (1) according to any one of [1] to [6], in which the monitoring circuit (10) includes means configured to wirelessly communicate with the detector (11).
[8] The structural health monitoring system (1) according to any one of [1] to [7], in which
   the monitoring circuit (10) includes an RFID tag including the detector (11),
   the determiner (30 and 40) includes an RFID reader (30) configured to read the electrostatic capacitance from the RFID tag, and a mobile device (40) configured to determine a healthy state or a damaged state of the base material (101) based on the electrostatic capacitance obtained from the RFID reader (30), and
   the mobile device (40) displays a result of the determination.
[9] The structural health monitoring system (1) according to [8], in which a plurality of the monitoring circuits (10) are provided at different positions of the monitoring object (100),
   the RFID tag provided in each of the plurality of monitoring circuits (10) is assigned with an identification symbol, and
   the mobile device (40) obtains the electrostatic capacitance corresponding to the identification symbol through the RFID reader (30), and determines the healthy state or the damaged state of the monitoring circuit (10) corresponding to the identification symbol based on the electrostatic capacitance corresponding to the identification symbol.
[10] A monitoring circuit (10) fixed to a surface of a monitoring object (100), in which
   the monitoring object (100) includes a base material (101) having conductivity, and an insulating layer (103) fixed to a surface of the base material (101),
   the monitoring circuit (10) includes a detector (11) configured to detect an electrostatic capacitance, and a conductive path (15) connected in series to the detector (11), and
   at least the conductive path (15) is fixed to a surface of the insulating layer (103).
[11] A structural health monitoring method determines health of a monitoring object (100) based on an electrostatic capacitance detected in a monitoring circuit (10) fixed to the monitoring object (100).

The monitoring object (100) includes a base material (101) having conductivity, and an insulating layer (103) fixed to a surface of the base material (101).

The monitoring circuit (10) includes a detector (11) configured to detect an electrostatic capacitance as a physical quantity, and a conductive path (15) connected in series to the detector (11), and
at least the conductive path (15) is fixed to a surface of the insulating layer (103).

In a damaged state where the base material (101) is damaged, electrostatic capacitances of parasitic capacitors generated by the base material (101), the insulating layer (103), and the conductive path (15) stacked in order are detected.

What is claimed is:

1. A structural health monitoring system, comprising:
a monitoring circuit configured to be fixed to a monitoring object; and
a determiner configured to determine health of the monitoring object based on a physical quantity detected in the monitoring circuit, wherein
the monitoring object includes a base material having conductivity, and an insulating layer fixed to a surface of the base material,
the monitoring circuit includes a detector configured to detect an electrostatic capacitance as the physical quantity, and a conductive path connected in series to the detector, and
at least the conductive path is fixed to a surface of the insulating layer.

2. The structural health monitoring system according to claim 1, wherein the determiner determines a healthy state where the base material is not damaged or a damaged state where the base material is damaged, based on the electrostatic capacitance obtained from the detector.

3. The structural health monitoring system according to claim 2, wherein
in the damaged state, parasitic capacitors are generated by the base material, the insulating layer, and the conductive path stacked in order, and
the detector detects electrostatic capacitances or a combined electrostatic capacitance of the parasitic capacitors.

4. The structural health monitoring system according to claim 3, wherein
when the conductive path is broken with damage of the base material, and is divided into at least two paths of a first path and a second path electrically independent of each other,
the detector detects one or both or a combined electrostatic capacitance of a first electrostatic capacitance of the parasitic capacitor generated in the first path and a second electrostatic capacitance of the parasitic capacitor generated in the second path, and
the determiner estimates a position of the breakage in the conductive path based on one or both or the combined electrostatic capacitance of the first electrostatic capacitance and the second electrostatic capacitance.

5. The structural health monitoring system according to claim 1, wherein
the monitoring circuit includes one or more buffer films each made of a conductive material and electrically connected to the conductive path, and
the one or more buffer films are fixed to the surface of the insulating layer of the monitoring object.

6. The structural health monitoring system according to claim 1, wherein
the monitoring circuit includes one or more existing capacitors electrically connected to the conductive path, and
the existing capacitors are fixed to the surface of the insulating layer of the monitoring object.

7. The structural health monitoring system according to claim 1, wherein the monitoring circuit includes means configured to wirelessly communicate with the detector.

8. The structural health monitoring system according to claim 7, wherein
the wireless communication means includes an RFID tag including the detector,
the determiner includes an RFID reader configured to read the electrostatic capacitance from the RFID tag, and a mobile device configured to determine a healthy state or a damaged state of the base material based on the electrostatic capacitance obtained from the RFID reader, and
the mobile device displays a result of the determination.

9. The structural health monitoring system according to claim 8, wherein a plurality of the monitoring circuits are provided at different positions of the monitoring object,
the RFID tag provided in each of the plurality of monitoring circuits is assigned with an identification symbol, and
the mobile device obtains the electrostatic capacitance corresponding to the identification symbol through the RFID reader, and determines the healthy state or the damaged state of the monitoring circuit corresponding to the identification symbol based on the electrostatic capacitance corresponding to the identification symbol.

10. A monitoring circuit fixed to a surface of a monitoring object, wherein
the monitoring object includes a base material having conductivity, and an insulating layer fixed to a surface of the base material,
the monitoring circuit includes a detector configured to detect an electrostatic capacitance, and a conductive path connected in series to the detector, and
at least the conductive path is fixed to a surface of the insulating layer.

11. A structural health monitoring method of determining health of a monitoring object based on an electrostatic capacitance detected in a monitoring circuit fixed to the monitoring object, wherein
the monitoring object includes a base material having conductivity, and an insulating layer fixed to a surface of the base material,
the monitoring circuit includes a detector configured to detect an electrostatic capacitance, and a conductive path connected in series to the detector,
at least the conductive path is fixed to a surface of the insulating layer, and
in a damaged state where the base material is damaged, electrostatic capacitances of parasitic capacitors generated by the base material, the insulating layer, and the conductive path stacked in order are detected.
